(19) United States
(12) Patent Application Publication
(10) Pub. No.: US 2012/0056356 A1
(43) Pub. Date: Mar. 8, 2012

(54) Blow Molding Process, Apparatus and Article

(75) Inventors: Daniel Hall, Smyrna, TN (US); William Matthew Foster, White House, TN (US); Dan Lockstadt, Castalian Springs, TN (US); Dale Escue, Portland, TN (US)

(73) Assignee: Salflex Polymers Ltd., Weston (CA)

(21) Appl. No.: 13/227,711

(22) Filed: Sep. 8, 2011

Related U.S. Application Data
(60) Provisional application No. 61/380,935, filed on Sep. 8, 2010.

(51) Int. Cl. B29C 49/04; B29C 49/32

(52) U.S. Cl. 264/533; 264/531; 425/541

(57) ABSTRACT

Provided is a process for producing a hollow article provided with an internal component. The process comprises providing a molding station having first and second mold portions together defining a mold cavity. A parison having a top and bottom end is then positioned within the molding station. Using a carrier, at least one component mounted on the carrier is inserted into the parison through the top end of the parison. The parison is then pressed against the component using displaceable mold cores provided in each of first and second mold portions, after which the carrier is removed from the molding station. The top and bottom ends of the parison are sealed, and the molding station is closed. Blow molding pressure is applied to the parison to urge the parison against the contours of the mold cavity, after which the molding station is opened and the formed hollow article is removed.

### CROSS-REFERENCE TO RELATED APPLICATION

This is a non-provisional application claiming priority under 35 USC §119 to U.S. Provisional Patent Application Ser. No. 61/380,935 filed on Sep. 8, 2010.

### FIELD OF THE INVENTION

The present invention relates to the production of hollow plastic articles, and in particular to a method and an apparatus for the blow-molding of hollow plastic articles with inserted components.

### BACKGROUND OF THE INVENTION

Blow moulded hollow articles can be made by the blow molding process. This is a common technique to make hollow articles such as fuel tanks or portable transport containers. The disadvantage of this polymer processing method is that that the integration of components inside the hollow plastic article after molding is very difficult and limited. For example, for fuel tanks components can be added after molding by inserting them through cut holes. These holes are subsequently covered by caps or with fuel tank components leaving an additional permeation path for fuel vapor permeation from the inside to the outside.

Another process known in the prior art is a twin-sheet forming process. Two half-shells are formed from sheets and welded together in a second step. It is possible to insert components between two half-shells before they are welded. A disadvantage of this thermoforming process over blow moulding is that the thickness of the extruded sheet is uniform resulting in uneven thinning in the finished part in high blow ratio areas. Another disadvantage is that there is an additional time and energy required to heat up the two-shells in order to be able to weld the shells.

Another process for producing hollow plastic articles is a twin-sheet, blow moulding process. The process encompasses forming a hollow parison with a blow moulding extrusion apparatus, splitting the parison into two sheets, thermoforming the sheets to form half-shells and then welding the shells together. Components may be added between the half-shells before the welding process. The disadvantage of this process is that a capital investment is required for parison splitting and twin sheet handling devices with poorer productivity arising from operating, maintaining and cleaning the additional devices.

### SUMMARY OF THE INVENTION

According to an aspect of an embodiment provided is a process for producing a hollow article provided with an internal component. The process comprises providing a molding station having first and second mold portions together defining a mold cavity. A parison having a top and bottom end is then positioned within the molding station. Using a carrier, at least one component mounted on the carrier is inserted into the parison through the top end of the parison. The parison is then pressed against the component using displaceable mold cores provided in each of the first and second mold portions, after which the carrier is removed from the molding station. The top and bottom ends of the parison are sealed, and the molding station is closed. Blow molding pressure is applied to the parison to urge the parison against the contours of the mold cavity, after which the molding station is opened and the formed hollow article is removed.

According to another aspect of an embodiment, provided is a blow molding apparatus for producing a hollow article provided with an internal component. The blow molding apparatus comprises a blow molding station having a first and second mold portion that together define a mold cavity, the blow molding station being configured to receive a parison. A carrier is positioned to deliver a component through a top end of the parison located in the blow molding station. Each of the first and second mold portions provides at least one displaceable mold core configured to engage the parison to urge localized contact between the parison and the component. A set of sliding pinch plates operably disposed above and below the first and second mold portions are also provided to seal the top and bottom ends, respectively.

### BRIEF DESCRIPTION OF THE DRAWINGS

The foregoing and other features and advantages of the invention will be apparent from the following description of the invention as illustrated in the accompanying drawings. The accompanying drawings, which are incorporated herein and form a part of the specification, further serve to explain the principles of the invention and to enable a person skilled in the pertinent art to make and use the invention. The drawings are not to scale.

FIG. 1 shows diagrammatically in cross-section the step of parison extrusion from an extruder.

FIG. 2 shows diagrammatically in cross-section the use of conveying device to transport a parison, according to the present invention.

FIG. 3 shows diagrammatically in cross-section the positioning of a parison within a blow molding station, according to the present invention.

FIGS. 4 and 5 shows diagrammatically in cross-section the use of a stretcher mechanism to widen the open top end of parison, according to the present invention.

FIG. 6 shows diagrammatically in cross-section the insertion of a component on a carrier within the parison in the blow molding station from the top of the machine, according to the present invention.

FIG. 7 shows diagrammatically in cross-section the extension of mold cores into the mold cavity to engage the parison and weld the component in position, according to the present invention.

FIG. 8 shows diagrammatically in cross-section the closure of pinch plates on the top and bottom ends of the parison to create a sealed internal chamber, according to the present invention.

FIG. 9 shows diagrammatically in cross-section the closure of the first and second mold portions to establish the final shape of the mold cavity, according to the present invention.

FIG. 10 shows diagrammatically in cross-section the parison in the mold cavity on being blow molded, according to the present invention.

FIG. 11 shows diagrammatically in cross-section the opening of the first and second mold portions to release the finished molded article, according to the present invention.

FIG. 12 shows diagrammatically in cross-section the insertion of a component on a carrier through the top end of the parison, and the insertion of a second component on a second carrier through the bottom end of the parison, according to an alternate embodiment of the present invention.

### DESCRIPTION OF PREFERRED EMBODIMENT

Specific embodiments of the present invention will now be described with reference to the figures. The following detailed description is merely exemplary in nature and is not intended to limit the invention or the application and uses of the invention. A person skilled in the relevant art will recognize that other configurations and arrangements can be used without departing from the scope of the invention. Although the description of the embodiments hereof is in the context of blow molding containers having inserted components, the invention may also be used in other blow molding arrangements. Furthermore, there is no intention to be bound by any expressed or implied theory presented in the preceding technical field, background, brief summary or the following detailed description.

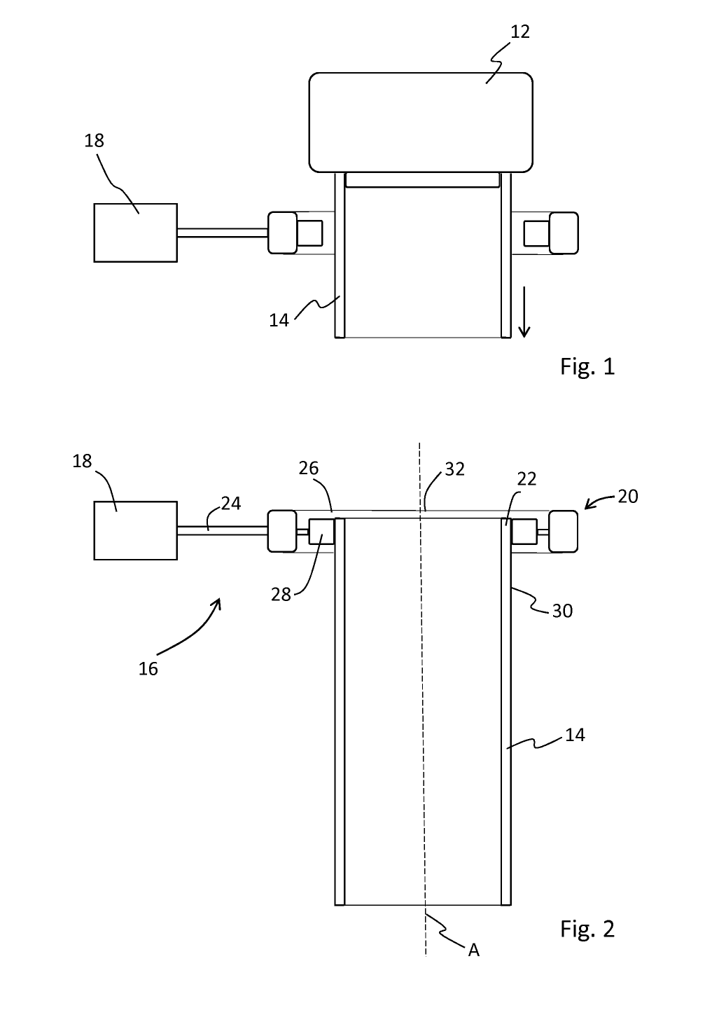

Presented diagrammatically in FIG. 1 is a cross-sectional view of an extrusion head 12 which operates to extrude a hollow tube-like segment of thermoplastic material generally referred to as a hollow parison 14. As shown in FIG. 2, after a predetermined length or segment of material has been extruded, parison 14 is taken hold by a suitable conveying device 16 and cut.

An exemplary conveying device 16 is a robotic assembly system 18 fitted with end-of-arm tooling suitable for handling a parison, for example a gripper assembly 20. A variety of configurations are possible for gripper assembly 20. Functionally, gripper assembly 20 is configured to grasp and release the top end 22 of parison 14 to permit for parison transport and control. Gripper assembly 20 may be attached to an extendible support 24 forming part of the robotic assembly system.

In one exemplary embodiment, robotic assembly system 18 is a 6-axis robot having an end-of-arm gripper assembly 20 comprised of a segmented vacuum ring 26 configured to contact and engage the outside surface of parison 14. As shown, segmented vacuum ring 26 is comprised of a plurality of vacuum units 28 that in total form a ring-like structure around top end 22 of parison 14. Each vacuum unit 28 is configured to move radially relative to axis A, so as to permit segmented vacuum ring 26 to open and close during initial engagement with parison 14. By virtue of gripper assembly 20 engaging and retaining parison 14 on the outside surface 30, parison 14 retains the tube-like hollow structure at top end 22. As such, gripper assembly 20 presents a central aperture 32 generally of similar diameter to parison 14, aperture 32 permitting for passage of components to be inserted in parison 14, as will be described below.

While gripper assembly 20 detailed above maintains parison 14 in a substantially circular ring-like configuration, alternate arrangements of the segmented units of gripper assembly are possible, such as to maintain top end 22 of parison 14 in a polygonal (e.g. hexagonal), square or non-circular shape.

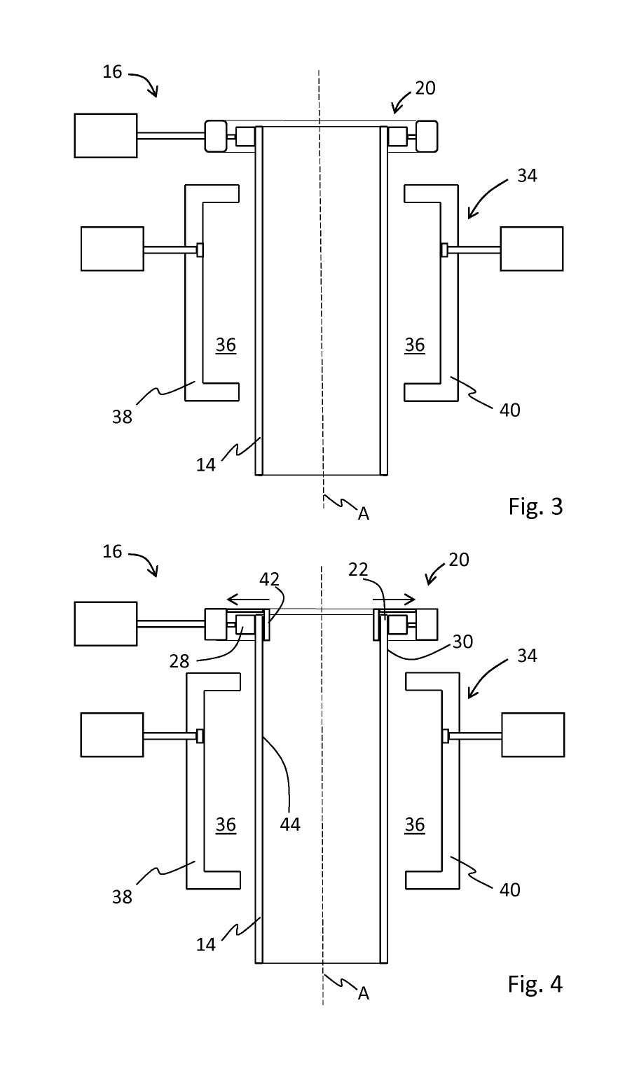

On grasping and retaining parison 14, conveying device 16 removes parison 14 from extrusion head 12, and delivers it to a blow molding station 34, as shown for example in FIG. 3. Blow-molding station 34 provides a mold cavity 36 shaped to form the desired hollow article, mold cavity 36 generally being defined by a first mold portion 38 and a second mold portion 40. First and second mold portions 38, 40 are movable to open/close mold cavity 36, enabling the loading of parison 14 at the beginning of a mold cycle, and the unloading of the finished hollow article at the end of the mold cycle.

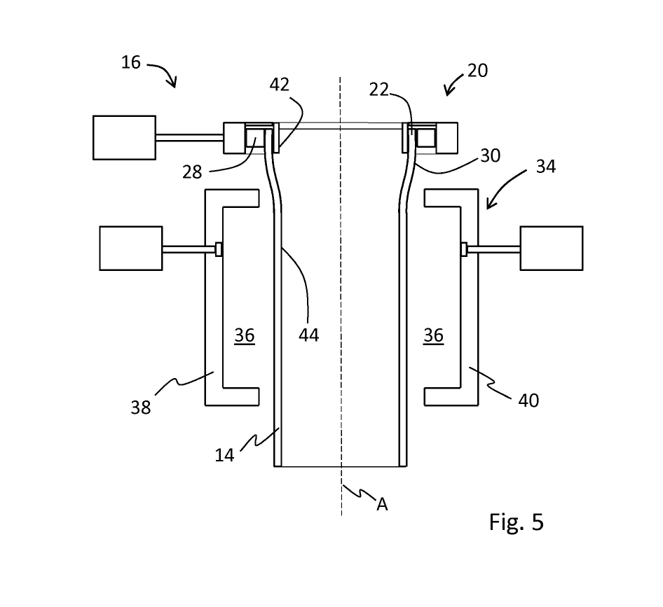

Components to be inserted into parison 14 prior to blow-molding are inserted through top end 22. To facilitate the insertion of larger components into parison 14, as shown in FIGS. 4 and 5, top end 22 of parison 14 may be stretched to increase the overall opening relative to the original diameter. To achieve this, each vacuum unit 28 of gripper assembly 20 may be displaced outwardly relative to axis A, so as to promote the opening of top end 22. In addition, to provide additional stretching force on parison 14, conveying device 16 may further include a stretcher mechanism comprising a plurality of stretch rods or fingers 42 to engage the inside surface 44 of parison 14. The plurality of stretch rods 42 are arranged in an annular series relative to axis A of parison 14. To promote the opening of top end 22, at least 3 stretch rods are required, but it will be appreciated that a greater number of stretch rods 42 may be advantageously used to reduce localized stresses during opening. For example, in one embodiment, 6 to 8 stretch rods 42 may be used. Regardless of the number of stretch rods 42 used, stretch rods 42 are equally spaced about axis A. Functionally, stretch rods 42 are movable from a normal rest position corresponding to the original size of top end 22 (as shown in FIG. 4) to an extended position in which stretch rods 42 have been moved radially outward to expand top end 20 of parison 14 (as shown in FIG. 5). As top end 22 is retained on outside surface 30 by gripper assembly 20, the radial displacement of the stretch rods 42 is matched to and coordinated with the radial displacement of the vacuum units 28 defining gripper assembly 20.

While parison 14 may be symmetrically stretched, that is each point on top end 22 being displaced by the same radial extent, it is not necessary for this to occur. In some embodiments, through the action of the matched stretch rods 42 and vacuum units 28, points about top end 22 of parison 14 may be moved to different radial extents to achieve a certain shaped opening. As such, the manipulation of top end 22, in particular of the opening may be either symmetrical or non-symmetrical depending on the desired shape to be achieved.

In some embodiments, to ensure engagement between stretch rods 42 and parison 14, stretch rods 42 may be provided with offsets (not shown). Offsets serve to securely engage inside surface 44 of parison 14 to assist in preventing parison 14 from dropping under weight/gravity. Alternatively, stretch rods 42 may incorporate gripping features that include mechanical or vacuum based engagement with inside surface 44 of parison 14.

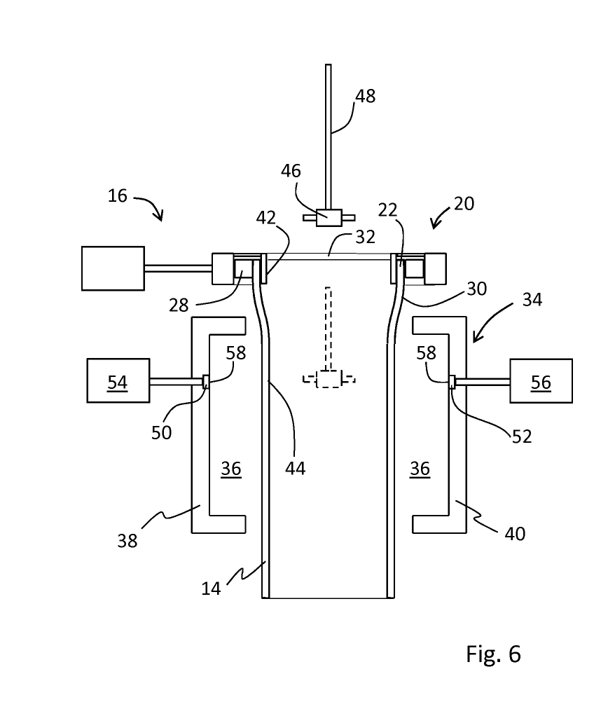

Turning now to FIG. 6, with parison 14 positioned within blow molding station 34, and top end 22 expanded to present an enlarged opening, a component 46 is inserted into parison 14. To achieve this, component 46 is mounted on a suitable carrier 48 configured to deliver component 46 to a predetermined position inside parison 14 (shown in dot). Carrier 48 and component 46 are inserted through aperture 32 provided on gripper assembly 20.

Each of first and second mold portions 38, 40 provide at least one respective movable mold core 50, 52 that are displaceable relative to mold cavity 26. As such, mold cores 50, 52 are configured to protrude and retract from mold cavity 36, so as to engage/disengage from parison 14. To facilitate movement, mold cores 50, 52 may be coupled to a respective actuator 54, 56 capable of lateral displacement. As will be appreciated, the stroke provided by actuator 54, 56 may be adjustable to allow for accurate positioning of end surface 58 of mold cores 54, 56 relative to the fully extended and fully retracted positions. For example, in the retracted position, end surface 58 may be partially protruding, flush, or partially recessed relative to inside surface 60 of mold cavity 36. It will be further appreciated that while a single actuator may be used to control the movement of mold core 50, 52, in some embodiments, particularly where a plurality of mold cores are provided, a yoke plate configuration (not shown) may be implemented.

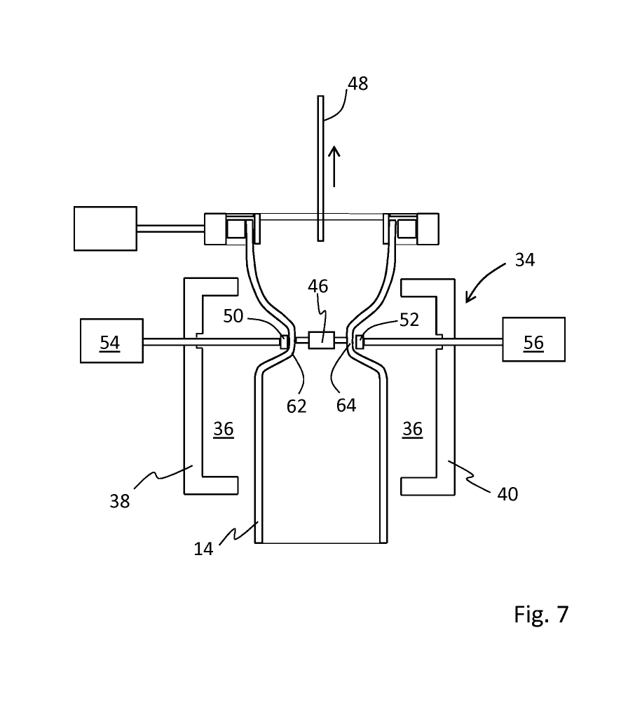

Turning now to FIG. 7, with component 46 positioned within parison 14, mold cores 50, 52 in each of first and second mold portions 38, 40 are extended into mold cavity 36, thereby engaging parison 14. As the walls of parison 14 are locally pushed inwardly by mold cores 50, 52, thus forming protrusions 62, 64, they are urged into contact with component 46, resulting in a permanent bond or weld to maintain component 46 in position. Once the points of contact are established, carrier 48 is detached from component 46 and withdrawn from mold cavity 36.

In some embodiments, prior to extending mold cores 50, 52 into mold cavity 36, first and second mold portions 38, 40 may be partially closed to an intermediate position.

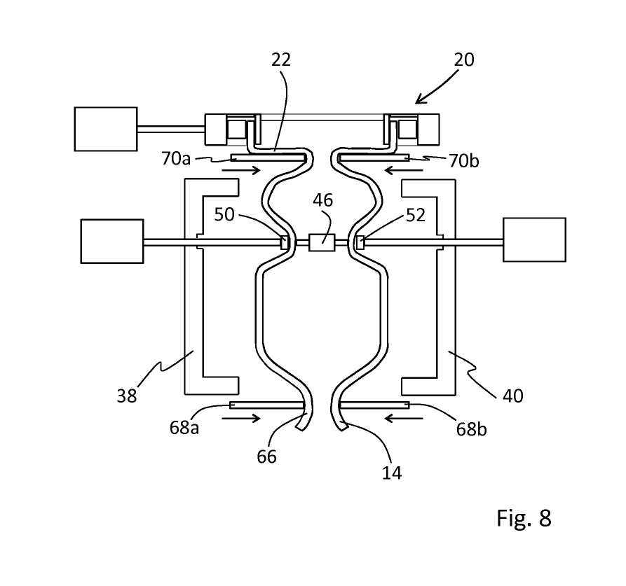

As shown in FIG. 8, the bottom end 66 of parison 14 is sealed using a first set of sliding pinch plates 68a/68b operably disposed below first and second mold portions 38, 40. Sliding pinch plates 68a/68b are configured to slide towards each other, thereby effecting closure of the distal end of parison 14. Similarly, top end 22 of parison 14 is sealed using a second set of sliding pinch plates 70a/70b disposed below the stretcher mechanism. While the first and second sets of sliding pinch plates 68a/68b, 70a/70b] may be integrated into the gripper assembly 20 structure, the pinch plates may alternatively be part of a separate pre-blow assembly that is moved into position, for example through the use of a robot.

Parison 14 is subject to a pre-blow pressure by way of pressurized gas (e.g. air) introduced through one or more blow needles/pins (not shown) in fluid communication with the internal chamber formed within the sealed parison 14.

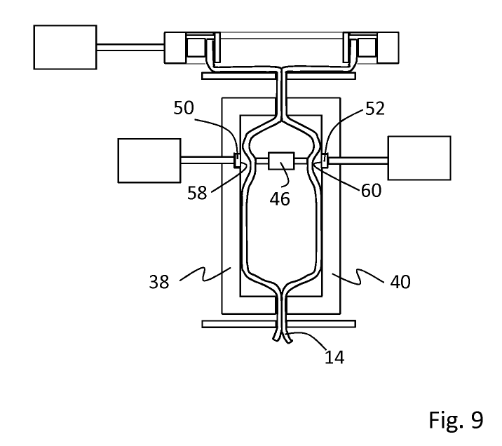

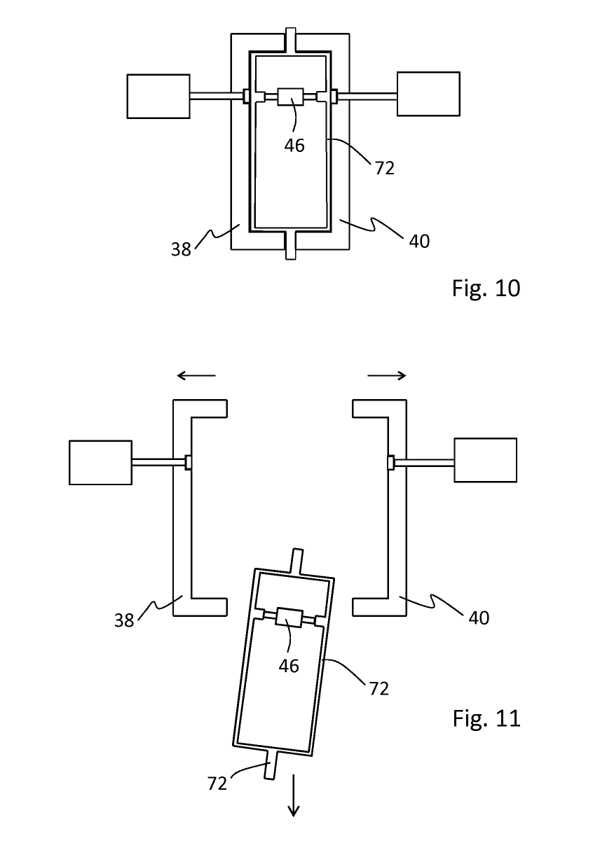

As shown in FIG. 9, first and second mold portions 38, 40 are then closed, with mold cores 50, 52 being retracted to disengage parison 14. Mold cores 50, 52 are retracted sufficiently to position end surface 58 at a location to achieve the desired end feature in the finished article. In the embodiment shown, mold cores 50, 52 are retracted sufficiently to position end surface 58 at a location flush with the inside surface 60 of mold cavity 36, so as to minimize surface markings on the finished article. With first and second mold portions 38, 40 fully closed, blow molding pressure is applied through the one or more blow needles/pins (not shown). As such, parison 14 is caused to bear completely against the contour of mold cavity 48, thus forming the final hollow article 72, shown in FIG. 10.

As shown in FIG. 11, on completion of the blow molding step and cooling period, first and second mold portions 38, 40 are opened, and the resulting hollow article 72 is removed and subjected to any required post-mold processing to remove flashing 74 or other waste material. The finished hollow article 72 comprises inserted component 46 in permanent welded contact with the inside surface.

While parison 14 is subject to a pre-blow step prior to full blow molding, in some embodiments, the pre-blow step may be excluded.

While sliding pinch plates 68a/68b, 70a/70b are shown to effect a substantially complete closure of the end regions of parison 14, one or both sets of sliding pinch plates 68a/68b, 70a/70b may also be configured to bear against plug members inserted within the top and/or bottom portions of parison 14. As such, pinch plates 68a/68b, 70a/70b would inwardly displace and bear against the plug members, allowing for a pre-blow pressurization, subsequent to which first and second mold portions 38, 40 would be fully closed to permit for blow molding under full blow molding pressure.

While component 46 may be permanently welded to a generally planar region of the inside surface of finished article, it may also be positioned to permanently weld to a protrusion or generally non-planar region.

While the above discussion presents mold cavity 36 as being defined by first and second mold portions 38, 40 in some embodiments mold cavity 36 may be defined by a greater number of mold portions.

While the above discussion presents a blow molding arrangement wherein a single component 46 is inserted through top end 22 of parison 14, carrier 48 may be configured to deliver a plurality of components 46 through top end 22. Alternatively, multiple carriers 48 may be used to position one or more components through top end 22.

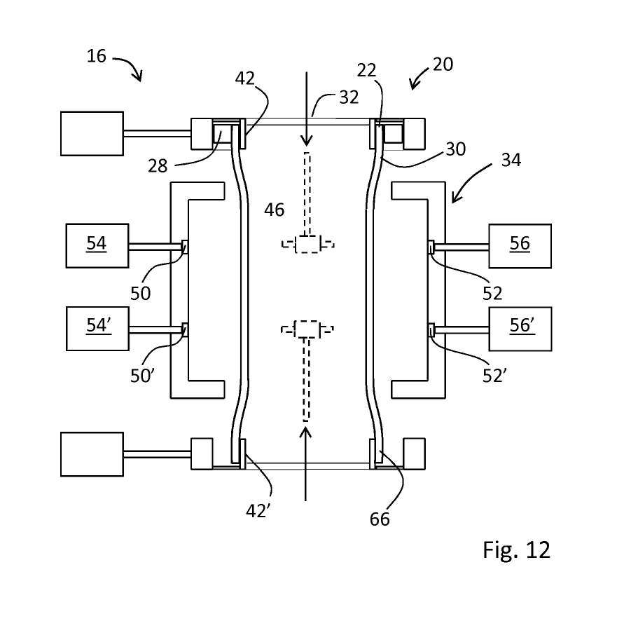

In still further embodiments, the above arrangement of delivering a component through top end 22 of parison 14 may be combined with a conventional bottom-load arrangement, for example as shown in FIG. 12. As shown, two components 46/46′ are inserted into parison 14. Component 46 is inserted through top end 22 as previously described. Component 46′ is inserted through bottom end 66, where bottom end 66 is opened using a stretcher mechanism. Similar to that used for opening top end 22, the stretcher mechanism used on bottom end 66 may comprise a plurality of stretch rods 42′ arranged in an annular series relative to axis A of parison 14. While at least 3 stretch rods are required, it will be appreciated that a greater number of stretch rods 42′ may be advantageously used to reduce localized stresses during opening. For example, in one embodiment, 6 to 8 stretch rods 42′ may be used. Regardless of the number of stretch rods 42′ used, stretch rods 42′ are equally spaced about axis A. Functionally, stretch rods 42′ are movable from a normal rest position corresponding to the original size of bottom end 66 of parison 14, to an extended position in which stretch rods 42′ have been moved radially outward to expand bottom end 66 of parison 14 (as shown in FIG. 12). As such, a carrier 48′ can be inserted into bottom end 66 to deliver component 46′ to a predetermined positioned inside parison 14. Mold cores 50′, 52′ operate similar to previously described mold cores 50, 52 to engage/disengage from parison 14, with the purpose of urging parison 14 into contact with component 46′. The remaining processing steps to form the final hollow article are similar to those previously described and shown in FIGS. 7 through 11.

In still further embodiments, multiple carriers, that is both top and bottom insertion carriers may be used to position a single component (e.g. a fuel tank baffle) in a parison. For example, each of the top and bottom carriers may present a portion of a component that upon insertion and final positioning, the portions together form a single assembled component within the parison. In still further arrangements, a component may be inserted via either the top or bottom carrier, with the other opposing carrier providing guidance means during subsequent engagement by the parison.

A variety of hollow articles can be manufactured by means of the process described above. One application of the method is in the production of a fuel tank used for motor vehicles. The hollow article can also be used as a fuel tank for off road vehicles, marine vessels, lawn and garden devices and power tools. The method can also be used for the manufacture of containers to store and transport fuel, liquids or chemicals.

The internal component of the hollow article may be a structural element to reduce deformation of the hollow article upon pressurization above ambient external pressure. In other embodiments, the internal component may be a wave management member (e.g. baffle) to reduce propagated sloshing noise from a liquid filled hollow article, such as a fuel tank. In still further embodiments, particularly where the hollow article is a fuel tank, the internal component may be a baffle, a structural anti-deflection element, a valve, a pump module, a sensor/sensor mechanism, and/or a surge chamber.

The hollow articles may be formed from a mono-layer parison comprised of a thermoplastic material. A non-limiting example of suitable thermoplastic material includes high density polypropylene, propylene, polyamide, acetal, polyester, fluoropolymer, polyphenylene sulfide, and copolymers of these plastics.

In addition to mono-layer parisons, the hollow articles may be made from a co-extruded or multi-layer parison comprised of thermoplastic material. A non-limiting example of suitable thermoplastic material includes high density polypropylene, propylene, polyamide, acetal, polyester, fluoropolymer, polyphenylene sulfide, and copolymers of these plastics.

The mono-layer and co-extruded/multi-layer parisons may be formed of thermoplastic material(s) containing a barrier resin such as SELAR™, or inorganic additives including minerals and glass.

Multi-layer parisons may comprise a filled or unfilled structural layer, generally a thermoplastic material, an adhesive layer and a barrier layer. A non-limiting example of suitable barrier layers includes ethylene vinyl alcohol, fluoropolymer, polyamide, acetal, polyester polyphenylene sulfide and copolymers thereof.

While various embodiments according to the present invention have been described above, it should be understood that they have been presented by way of illustration and example only, and not limitation. It will be apparent to persons skilled in the relevant art that various changes in form and detail can be made therein without departing from the scope of the invention. Thus, the breadth and scope of the present invention should not be limited by any of the above-described exemplary embodiments, but should be defined only in accordance with the appended claims and their equivalents. It will also be understood that each feature of each embodiment discussed herein, and of each reference cited herein, can be used in combination with the features of any other combination. All patents and publications discussed herein are incorporated by reference herein in their entirety.

1. A process for producing a hollow article provided with internal components, the process comprising:
providing a molding station having first and second mold portions together defining a mold cavity,
positioning within said molding station a parison having a top end and a bottom end,
inserting through said top end of said parison a carrier having positioned thereon at least one component to be inserted into said parison,
pressing said parison against said component using displaceable mold cores provided in each of said first and second mold portions,
removing said carrier from said molding station,
sealing said top and bottom ends of said parison,
closing said molding station,
applying blow molding pressure to said parison to urge said parison against the contour of said mold cavity, and
opening said molding station and removing the formed hollow article.

2. The process according to claim 1, wherein said parison is extruded from an extrusion head, cut to a predetermined length, and transported to said molding station using a conveying device.

3. The process according to claim 1, further comprising opening said top end of said parison to facilitate the insertion of said carrier and component mounted thereon.

4. The process according to claim 3, wherein said top end of said parison is opened using a stretcher mechanism.

5. The process according to claim 1, further comprising partially closing said first and second mold portions prior to pressing said parison against said component using said displaceable mold cores.

6. The process according to claim 1, further comprising subjecting the closed preform to a pre-blow pressure prior to closing said molding station.

7. The process according to claim 1, further comprising inserting through said bottom end of said parison a second carrier having positioned thereon at least one component to be inserted into said parison.

8. The process according to claim 7, further comprising opening said bottom end of said parison to facilitate the insertion of said second carrier and component mounted thereon.

9. A blow molding apparatus for producing a hollow article provided with internal components, comprising,
a blow molding station having first and second mold portions together defining a mold cavity, said blow molding station being configured to receive a parison,
a carrier positioned to deliver a component through a top end of said parison located in said blow molding station,
at least one displaceable mold core in each of said first and second mold portions, said displaceable mold core being configured to engage said parison to urge localized contact between said parison and said component, and
a set of sliding pinch plates operably disposed above and below said first and second mold portions to seal said top and bottom ends, respectively.

10. The apparatus according to claim 9, further comprising a conveying device to receive and transport said parison from an extrusion head to said molding station.

11. The apparatus according to claim 10, wherein said conveying device is configured to engage an outside surface of said parison.

12. The apparatus according to claim 11, wherein said conveying device comprises a gripper assembly having a segmented vacuum ring configured to engage said outside surface of said parison.

13. The apparatus according to claim 10, further comprising a stretcher mechanism provided on said conveying device, said stretcher mechanism having a plurality of stretch rods arranged to engage and inside surface of said parison, said stretch rods being radially movable to outwardly stretch said top end of said parison.

14. The apparatus according to claim 13, wherein said stretcher mechanism comprises between 6 to 8 stretch rods arranged in annular series about said parison.

15. The apparatus according to claim 9, wherein each of said at least one displaceable mold cores is coupled to a respective actuator.
